(19) United States
(12) Patent Application Publication
(10) Pub. No.: US 2026/0062549 A1
(43) Pub. Date: Mar. 5, 2026

(54) ONE-PART CURABLE EPOXY COMPOSITION

(71) Applicant: Henkel AG & Co. KGaA, Duesseldorf (DE)

(72) Inventors: ChuanYong Zhang, Shanghai (CN); FuCai Cai, Shanghai (CN); YiJia He, Shanghai (CN); XiaoKe Zhang, Shanghai (CN)

(21) Appl. No.: 19/386,556

(22) Filed: Nov. 12, 2025

Related U.S. Application Data
(63) Continuation of application No. PCT/CN2023/095281, filed on May 19, 2023.

(51) Int. Cl. C08L 63/00; C08G 59/24; C08G 59/40; C08K 3/22; C08K 3/36; C08K 5/3435; C08K 5/5435

(52) U.S. Cl. CPC C08L 63/00; C08G 59/24; C08G 59/4021; C08G 59/4035; C08K 3/22; C08K 3/36; C08K 5/3435; C08K 5/5435; C08G 2170/00; C08K 2003/2241; C08L 2207/53

(57) ABSTRACT

The present invention provides a one-part curable epoxy composition comprising:
(A) from 20 to 90 wt. % of a non-aromatic epoxy resin, based on the total weight of the composition;
(B) a non-aromatic curing agent and optionally a non-aromatic accelerator, which is a combination of a dicyandiamide and a non-aromatic urea accelerator, or a dihydrazide represented by the following general formula (I):

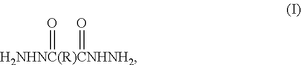

wherein R is an organic radical containing no heterocycle;
(C) a UV stabilizer; and
(D) a rubber with a core-shell structure.

The present invention further provides a cured product of the one-part curable epoxy composition, an article comprising the cured product, and use of the one-part curable epoxy composition or the cured product in electronic device.

### TECHNICAL FIELD

The present invention relates to a one-part curable epoxy composition and particularly relates to a one-part curable epoxy composition, upon curing, exhibiting both color stability and good bonding strength; a cured product thereof; an article comprising the cured product; and use of the composition or the cured product.

### BACKGROUND OF THE INVENTION

Curable epoxy-based materials are well known. Such compositions are used as adhesive, coating agents, sealing agents and may also be used as casting agents. Epoxy-based compositions are also used in the electronics industry. However, conventional epoxy-based materials are not color stable: they yellow and/or darken dramatically when exposed to heat, UV light, or household chemicals. This instability limits their application for adhesive bonding applications that are at least partially cosmetic, for example, in a visible location on the external portion of an electronic device. Thus, color stable epoxy-based adhesives are needed for certain cosmetic applications.

Electronic devices or electronic device components are often subjected to further processing steps after an adhesive is applied to the electronic device or electronic device component. For example, certain aluminium electronic device components can be subjected to a chemical anodization process or dye infusion process at later stages of a device build. Both of these processes involve the use of harsh chemical treatments. Conventional epoxy-based materials yellow or darken significantly under these conditions and therefore cannot be used for cosmetic applications. Accordingly, in addition to excellent adhesion and color stability in the presence of heat, UV light, or household chemicals, for some applications, epoxy materials which are also color stable even when exposed to chemical anodization or dye infusion processes are desired.

In view of the above, it would be desirable to provide a one-part curable epoxy composition, upon curing, exhibiting both color stability and good adhesion, in particular exhibiting a combination of a low color change in a Q-sun test, a low color change after anodic process of metals, and a strong adhesion to metals.

### SUMMARY OF THE INVENTION

The present invention provides a one-part curable epoxy composition comprising:
(A) from 20 to 90 wt. % of a non-aromatic epoxy resin, based on the total weight of the composition;
(B) a non-aromatic curing agent and optionally a non-aromatic accelerator, which is a combination of a dicyandiamide and a non-aromatic urea accelerator, or a dihydrazide represented by the following general formula (I):

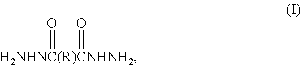

wherein R is an organic radical containing no heterocycle;
(C) a UV stabilizer; and
(D) a rubber with a core-shell structure.

The present invention also provides a cured product of the one-part curable epoxy composition according to the present invention.

The present invention further provides an article comprising the cured product according to the present invention.

Moreover, the present invention provides a use of the one-part curable epoxy composition according to the present invention in electronic device.

All of the one-part curable epoxy composition, the cured product, the article and the use according to the present invention are based on the following surprising discoveries of the inventors: the one-part curable epoxy composition according to the present invention comprising a combination of components (A) to (D), upon curing, exhibits both color stability and good adhesion, in particular exhibits a combination of a low color change after Q-sun test, a low color change after anodic process of metals, and a strong adhesion to metals; and especially, it exhibits a combination of Δ E 94 color changes ≤3 after Q-sun tests under 2.5 W for 150 hours and 250 hours respectively, a Δ E 94 color change ≤3 after pickling in an anodic process of metals, a lap shear strength ≥20 Mpa for Ti to Ti, and a lap shear strength ≥20 Mpa for AnAl (Anodic Aluminum Oxide) to AnAl.

### DETAILED DESCRIPTION OF THE INVENTION

It is to be understood by one of ordinary skill in the art that the present discussion is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, as used herein, the terms “a”, “an” and “the” include both singular and plural referents. That is to say, the terms “a”, “an” and “the” are used interchangeably with “at least one” to mean one or more of the elements being described.

The terms “comprising” and “comprises” as used herein are synonymous with “including”, “includes”, “containing” or “contains”, and are inclusive or open-ended and do not exclude additional, non-recited members, elements or process steps.

The term “non-aromatic” as used herein refers to compounds that do not include aryl or arylene groups.

As used herein, the Δ E 94 color change is measured according to ASTM E1347-06 (2020) standard.

As used herein, the lap shear strength is measured according to ASTM D1002-10 (2019) standard.

Unless specified otherwise, the recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skill in the art to which this invention belongs.

According to the present invention, surprisingly, the inventors of the present invention found that a one-part curable epoxy composition comprising:
(A) from 20 to 90 wt. % of a non-aromatic epoxy resin, based on the total weight of the composition;
(B) a non-aromatic curing agent and optionally a non-aromatic accelerator, which is a combination of a dicyandiamide and a non-aromatic urea accelerator, or a dihydrazide represented by the following general formula (I):

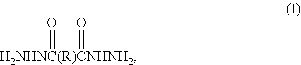

wherein R is an organic radical containing no heterocycle;
(C) a UV stabilizer; and
(D) a rubber with a core-shell structure, can exhibit both color stability and good adhesion upon curing.

In a first aspect, the present disclosure is generally directed to a one-part curable epoxy composition comprising:
(A) from 20 to 90 wt. % of a non-aromatic epoxy resin, based on the total weight of the composition;
(B) a non-aromatic curing agent and optionally a non-aromatic accelerator, which is a combination of a dicyandiamide and a non-aromatic urea accelerator, or a dihydrazide represented by the following general formula (I):

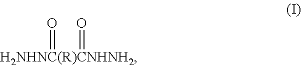

wherein R is an organic radical containing no heterocycle;
(C) a UV stabilizer; and
(D) a rubber with a core-shell structure.

### (A) Non-Aromatic Epoxy Resin

According to the present invention, the one-part curable epoxy composition comprises (A) from 20 to 90 wt. % of a non-aromatic epoxy resin, based on the total weight of the composition. In some embodiments, the non-aromatic epoxy resin is the major reactive component of the one-part curable epoxy composition according to the present invention.

Preferably, the non-aromatic epoxy resins include diglycidyl ether based epoxy resins and alicyclic epoxy resins such as diepoxy acetals, diepoxy adipate, diepoxy carboxylates, and dicyclopentadiene-based epoxy resins; isocyanurate derivative epoxy resins such as triglycidyl isocyanurate; and hydrogenated epoxy resins prepared by hydrogenating the aromatic ring(s) within aromatic epoxy resins such as bisphenol A epoxy resins, bisphenol F epoxy resins, phenol novolak epoxy resins, cresol novolak epoxy resins, naphthalene epoxy resins, biphenyl epoxy resins, aralkyl epoxy resins and biphenylarakyl epoxy resins. Two or more of these resins may also be used in combination. More preferably, the non-aromatic epoxy resin is a hydrogenated epoxy resin prepared by hydrogenating the aromatic ring(s) within aromatic epoxy resins such as bisphenol A epoxy resins, bisphenol F epoxy resins, phenol novolak epoxy resins, cresol novolak epoxy resins, naphthalene epoxy resins, biphenyl epoxy resins, aralkyl epoxy resins and biphenylarakyl epoxy resins. Most preferably, the non-aromatic epoxy resin is a hydrogenated bisphenol A epoxy resin.

Examples of commercially available non-aromatic epoxy resins include, but are not limited to, JER YX-8000D, JER YX-8034, and JER YX-8040 from Mitsubishi Chemical; and EPALLOY® 5000 from Huntsman Corporation. Preferably, the non-aromatic epoxy resin is the one under the trade name of JER-YX 8000D from Mitsubishi Chemical.

In a preferred embodiment of the present invention, the amount of the non-aromatic epoxy resin is from 30 to 90 wt. %, preferably from 42 to 85 wt. %, and more preferably from 42 to 80 wt. %, each based on the total weight of the composition. If the amount of the non-aromatic epoxy resin is higher than 90 wt. %, the adhesion to metal of the composition will be low. If the amount of the non-aromatic epoxy resin is lower than 20 wt. %, the color stability of the composition will be poor.

In a preferred embodiment of the present invention, the one-part curable epoxy composition contains no aromatic epoxy resin.

### (B) Non-Aromatic Curing Agent and Optionally Non-Aromatic Accelerator

According to the present invention, the one-part curable epoxy composition comprises (B) a non-aromatic curing agent and optionally a non-aromatic accelerator, which is a combination of a dicyandiamide and a non-aromatic urea accelerator, or a dihydrazide represented by the following general formula (I):

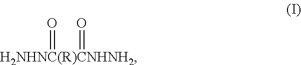

wherein R is an organic radical containing no heterocycle.

### a Combination of a Dicyandiamide and a Non-Aromatic Urea Accelerator

In an embodiment of the present invention, the one-part curable epoxy composition comprises a combination of a dicyandiamide and a non-aromatic urea accelerator as component (B).

Dicyandiamide has the following general chemical structure:

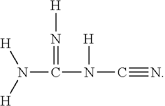

Examples of commercially available dicyandiamide include, but are not limited to, Omicure DDA 5, Omicure DDA 10, Omicure DDA 50, and Omicure DDA 100 (all from Huntsman); Dicyanex 1400B, Amicure CG-1200G, Amicure CG-325G, and Dicyanex 1400F (all from Evonik); and Dyhard 100, Dyhard 1100S, Dyhard 100SH, Dyhard 100SF, and Ecure 14 (all from Alzchem Group). Preferably, the dicyandiamide is the one under the trade name of Omicure DDA 5 from Huntsman.

The non-aromatic urea accelerator can be any conventional non-aromatic urea accelerator in the art, which is used together with dicyandiamide, as long as it does not negatively affect the desired technical effects of the inventive composition. Preferably, the non-aromatic urea accelerator is a cycloaliphatic substituted urea. More preferably, the non-aromatic urea accelerator is isophorone diurea.

Examples of commercially available non-aromatic urea accelerator include, but are not limited to, Omicure U 35 M from Huntsman.

In a preferred embodiment of the present invention, the amount of the dicyandiamide and the non-aromatic urea accelerator is from 3 to 10 wt. %, preferably from 4 to 8 wt. %, and more preferably from 5 to 7 wt. %, each based on the total weight of the composition.

### Dihydrazide Represented by the General Formula (I)

In another embodiment of the present invention, the one-part curable epoxy composition comprises a dihydrazide represented by the following general formula (I) as component (B):

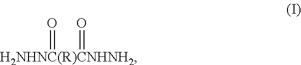

wherein R is an organic radical containing no heterocycle.

In a preferred embodiment of the present invention, the dihydrazide is the one, wherein R is a divalent hydrocarbon radical chosen from saturated or unsaturated aliphatic hydrocarbon radicals having from 2 to 20 carbon atoms, preferably saturated or unsaturated linear aliphatic hydrocarbon radicals having from 10 to 20 carbon atoms, and more preferably saturated or unsaturated linear aliphatic hydrocarbon radicals having 18 carbon atoms. The saturated or unsaturated aliphatic hydrocarbon radicals may be substituted or unsubstituted, and preferably is unsubstituted. Preferably, the saturated or unsaturated linear aliphatic hydrocarbon radicals merely contain alkyl and/or alkenyl, and more preferably contain alkyl and alkenyl. In another preferred embodiment of the present invention, the dihydrazide is selected from the group consisting of 7,11-octadecadiene-1,18-dicarbxylic acid dihydrazide, sebacic acid dihydrazide, adipic acid dihydrazide, icosanedioic acid dihydrazide, succinic acid dihydrazide, pimelic acid dihydrazide, suberic acid dihydrazide, azelaic acid dihydrazide, sebacic acid dihydrazide, dodecanediohydrazide, hexadecanediohydrazide, fumaric acid dihydrazide, tartaric acid dihydrazide, sebacic dihydrazide, adipic dihydrazide, and combinations thereof. Preferably, the dihydrazide is selected from the group consisting of 7,11-octadecadiene-1,18-dicarbxylic acid dihydrazide, sebacic acid dihydrazide, dodecanediohydrazide, adipic dihydrazide, and combinations thereof. More preferably, the dihydrazide is 7,11-octadecadiene-1,18-dicarbxylic acid dihydrazide, which has the following structure:

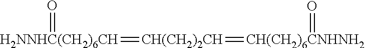

Examples of commercially available dihydrazide represented by the general formula (I) include, but are not limited to, Ajicure UDH-J and Ajicure UDH from Ajinomoto; and sebacic dihydrazide, dodecanediodihydrazide and adipic dihydrazide from Otsuka Chemical Co., Ltd. Preferably, the dihydrazide represented by the general formula (I) is Ajicure UDH-J and/or Ajicure UDH from Ajinomoto.

In a preferred embodiment of the present invention, the amount of the dihydrazide represented by the general formula (I) is from 15 to 35 wt. %, preferably from 20 to 30 wt. %, and more preferably from 21 to 25 wt. %, each based on the total weight of the composition.

In a preferred embodiment of the present invention, the amount of the non-aromatic curing agent and optionally a non-aromatic accelerator (B) is from 3 to 40 wt. %, preferably from 4 to 30 wt. %, and more preferably from 4 to 25 wt. %, each based on the total weight of the composition.

### (C) UV Stabilizer

According to the present invention, the one-part curable epoxy composition comprises (C) a UV stabilizer.

The UV stabilizer can be any conventional UV stabilizer in the art, as long as it does not negatively affect the desired technical effects of the inventive composition. Suitable UV stabilizers include, but are not limited to, hindered amine light stabilizers.

Examples of commercially available UV stabilizer include, but are not limited to, Thasorb UV-292 from Rianlon; and RIASORB UV-770, RIASORB UV-292, RIASORB UV-123, and RIASORB UV-144 from RIANLON Co., Ltd. Preferably, the UV stabilizer is the one under the trade name of Thasorb UV-292 from Rianlon.

The amount of the UV stabilizer can be determined by a technical specialist according to actual conditions.

(D) Rubber with a Core-Shell Structure

According to the present invention, the one-part curable epoxy composition comprises (D) a rubber with a core-shell structure, which is used as a toughening agent.

The rubber with a core-shell structure used in the present invention can be any conventional one in the art, as long as it does not negatively affect the desired technical effects of the inventive composition. Examples of commercially available rubber with a core-shell structure include, but are not limited to, Kane Ace B-564, Kane Ace M-731 and Kane Ace M-521 from Kaneka. Preferably, the rubber with a core-shell structure is the one under the trade name of Kane Ace B-564 from Kaneka.

In a preferred embodiment of the present invention, the amount of the rubber with a core-shell structure (D) is from 3 to 20 wt. %, and preferably from 4 to 18 wt. %, each based on the total weight of the composition.

### (E) Filler

According to the present invention, the one-part curable epoxy composition may further comprise (E) a filler.

The filler used in the present invention can be any conventional one in the art, as long as it does not negatively affect the desired technical effects of the inventive composition. Examples of commercially available filler include, but are not limited to, CAB-O-SIL Ts-720 Fumed Silica from Cabot; FE 920 A SQ, SE5200-SEJ and FEB25G-SED from Admatechs Co., Ltd. Preferably, the filler used in the present invention is a combination of CAB-O-SIL Ts-720 Fumed Silica and FE 920 A SQ.

In a preferred embodiment of the present invention, the amount of the filler (E) is from 5 to 50 wt. %, preferably from 7 to 29 wt. %, and more preferably from 8 to 25 wt. %, each based on the total weight of the composition.

### (F) Colorant

According to the present invention, the one-part curable epoxy composition may further comprise (F) a colorant.

The colorant used in the present invention can be any conventional one in the art, as long as it does not negatively affect the desired technical effects of the inventive composition. Examples of commercially available colorant include, but are not limited to, EHCH 15410 (white color) and EHCH 87163 (black color) from American Colors. Preferably, the colorant is the one under the trade name of EHCH 15410 from American Colors, which is a white color paste containing a hydrogenated bisphenol A type liquid epoxy resin, a non-aromatic epoxy diluent, titanium dioxide and a dispersant.

In a preferred embodiment of the present invention, the amount of the colorant (F) is from 0.1 to 10.0 wt. %, preferably from 2.0 to 8.0 wt. %, more preferably from 3.0 to 7.0 wt. %, each based on the total weight of the composition.

### (G) Non-Aromatic Epoxy Diluent

According to the present invention, the one-part curable epoxy composition may further comprise a non-aromatic epoxy diluent.

The non-aromatic epoxy diluent used in the present invention can be any conventional non-aromatic epoxy diluent in the art, as long as it does not negatively affect the desired technical effects of the inventive composition. Preferably, the non-aromatic epoxy diluent is a diglycidyl ether diluent. More preferably, the non-aromatic epoxy diluent is selected from the group consisting of 1,4-cyclohexanedimethanol diglycidyl ether, polyethylene glycol diglycidyl ether, poly(2-hydroxypropylene)glycol diglycidyl ether, polypropylene glycol diglycidyl ether, 1,3-bis(3-glycidoxypropyl)-1,1,3,3-tetramethyldisiloxane, and the combinations thereof. Most preferably, the non-aromatic epoxy diluent is 1,4-cyclohexanedimethanol diglycidyl ether.

Examples of commercially available non-aromatic epoxy diluent include, but are not limited to, KF EPIOL-LD204 from KUKDO FINECHEM Co., Ltd.; jER YED216D from Mitsubishi Chemical; and PG-207GS and ZX-1658GS from NIPPON STEEL. Preferably, commercially available non-aromatic epoxy diluent is selected from the group consisting of EPIOL-LD204 from KUKDO FINECHEM Co., Ltd, ZX-1658GS from NIPPON STEEL, and combinations thereof. More preferably, commercially available non-aromatic epoxy diluent is EPIOL-LD204 from KUKDO FINECHEM Co., Ltd.

In a preferred embodiment of the present invention, the amount of the non-aromatic epoxy diluent (G) is from 5 to 30 wt. %, preferably from 10 to 25 wt. %, more preferably from 15 to 22 wt. %, each based on the total weight of the composition.

In a preferred embodiment of the present invention, the one-part curable epoxy composition contains no aromatic epoxy diluent.

### (H) Coupling Agent

According to the present invention, the one-part curable epoxy composition may further comprise (H) a coupling agent.

The coupling agent used in the present invention can be any conventional one in the art, as long as it does not negatively affect the desired technical effects of the inventive composition. Preferably, the coupling agent is an epoxy functional silane. Examples of commercially available coupling agents include, but are not limited to, Silquest A-187 and Silquest A-186 from Momentive Performance Materials Inc. Preferably, the coupling agent is the one under the trade name of Silquest A-187 from Momentive Performance Materials Inc.

In a preferred embodiment of the present invention, the amount of the coupling agent is from 0.1 to 5 wt. %, preferably 0.3 to 3 wt. %, each based on the total weight of the composition.

In some embodiments of the present invention, the one-part curable epoxy composition may further optionally comprise additives which are commonly used in the art to which the present invention belongs, such as a flame retardant (such as ATH (aluminum trihydrate) or phosphate flame retardant), a thermal conductivity enhancer (such as boron nitride), a thixotropic agent or the combinations thereof, as long as they do not negatively affect the desired technical effects of the inventive composition. The presence, the type and the amount of the additive can be determined by a specialist in the art according to actual requirements.

In a preferred embodiment of the present invention, the one-part curable epoxy composition according to the present invention comprises:
(A) from 55 to 85 wt. %, preferably from 57 to 80 wt. %, of a non-aromatic epoxy resin, each based on the total weight of the composition;
(B) from 3 to 10 wt. %, preferably from 4 to 8 wt. % of a combination of a dicyandiamide and a non-aromatic urea accelerator, each based on the total weight of the composition;
(C) a UV stabilizer;
(D) a rubber with a core-shell structure; and
(E) optionally, from 5 to 20 wt. %, preferably from 7 to 15 wt. % of a filler, each based on the total weight of the composition.

In another preferred embodiment of the present invention, the one-part curable epoxy composition according to the present invention comprises:
(A) from 20 to 55 wt. %, preferably from 42 to 50 wt. %, of a non-aromatic epoxy resin, each based on the total weight of the composition;
(B) from 15 to 35 wt. %, preferably from 20 to 30 wt. %, of the dihydrazide represented by the general formula (I) as defined above, each based on the total weight of the composition;
(C) a UV stabilizer;
(D) a rubber with a core-shell structure; and
(E) optionally, from 17 to 30 wt. %, preferably from 20 to 25 wt. % of a filler, each based on the total weight of the composition.

The one-part curable epoxy composition according to the present invention can be prepared by any conventional preparation methods in the art. In particular, the composition can be prepared by a method comprising the following steps: (1) mixing together all the components except the curing agent and optional curing accelerator by mechanical stirring; and (2) adding the curing agent and optional curing accelerator in the mixture obtained in step (1), and further mixing the mixture by mechanical stirring to obtain a homogeneous composition.

The one-part curable epoxy composition according to the present invention may be used in bonding substrates together, which comprises: applying the one-part curable epoxy composition according to the present invention to a first substrate, bringing a second substrate in contact with the one-part curable epoxy composition applied to the first substrate, and subjecting the applied composition to conditions which allow the applied composition to be cured. The one-part curable epoxy composition may be applied by any conventional methods in the art, such as dispensing, injecting, spraying, flow-coating, blade-coating, brushing, pouring, immersion, impregnation, dripping, rolling, sprinkle coating, and immersion coating.

Preferably, the one-part curable epoxy composition is applied by dispensing or injecting. In the present invention, the substrate may be made from a metal, a glass, a resin-based composite, and a ceramic; and preferably, the substrate may be made from a metal. To be cured, the one-part curable epoxy composition may be heated to from 120 to 180° C. for 10 min to 150 min; and preferably, the composition is heated to 130° C. for 120 min, or 150° C. for 60 min.

In a second aspect, the present disclosure is directed to a cured product of the one-part curable epoxy composition according to the present invention, an article comprising the cured product, and use of the one-part curable epoxy composition or the cured product in electronic device.

The one-part curable epoxy compositions according to the present invention may be used for bonding metal structures where appearance is required, are anodic resistant and Q-sun resistant, and can be color-matched. Preferably, the one-part curable epoxy compositions may be used in electronic devices, preferably the one which contains a metal structure bonded exterior part, especially for watch housing gap fill, phone and tablet antenna split, and headphone antenna slot.

The one-part curable epoxy composition according to the present invention, upon curing, exhibits both color stability and good adhesion, in particular exhibits a combination of a low color change after Q-sun test, a low color change after anodic process of metals, and a strong adhesion to metals; and especially, it exhibits a combination of Δ E 94 color changes ≤3 after Q-sun tests under 2.5 W for 150 hours and 250 hours respectively, a Δ E 94 color change ≤3 after pickling in an anodic process of metals, a lap shear strength ≥20 Mpa for Ti to Ti, and a lap shear strength ≥20 Mpa for AnAl to AnAl.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

### Component (A)

Component a-1: JER YX-8000D, a non-aromatic epoxy resin (a hydrogenated bisphenol A), whose epoxy equivalent is 180-200 g/mol, available from Mitsubishi Chemical. Component a-2′: EPON Resin 828, an aromatic epoxy resin (a bisphenol A), whose epoxy equivalent is 188 g/mol, available from Hexion.

### Component (B)

Component b-1: Omicure DDA 5, a dicyandiamide curing agent, whose particle size is ≤10 microns, available from Huntsman.
Component b-2: Omicure U 35M, a non-aromatic urea accelerator, whose particle size is ≤10 microns, available from Huntsman.
Component b-3: Ajicure UDH-J, a dihydrazide curing agent represented by the following formula:

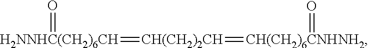

available from Ajinomoto.
Component b-4′: Ajicure VDH-J, a dihydrazide curing agent represented by the following formula:

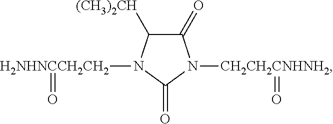

available from Ajinomoto.
Component b-5: Ajicure UDH, a dihydrazide curing agent represented by the following formula:

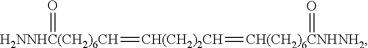

available from Ajinomoto.

### Component (C)

Component c-1: Thasorb UV-292, a UV stabilizer, available from Rianlon.

### Component (D)

Component d-1: Kane Ace B-564, a rubber with a core-shell structure, available from Kaneka.

### Component (E)

Component e-1: CAB-O-SIL Ts-720 Fumed Silica, a filler, available from Cabot.
Component e-2: Fe-920A SQ, a filler, available from Admatechs Co., Ltd.

### Component (F)

Component f-1: EHCH 15410, a white color paste (containing a hydrogenated bisphenol A type liquid epoxy resin, a non-aromatic epoxy diluent, titanium dioxide and a dispersant), available from American Colors.

### Component (G)

Component g-1: KF EPIOL LD-204, a non-aromatic epoxy diluent, whose epoxy equivalent is 150 g/mol, available from KUKDO FINECHEM Co., Ltd.
Component g-2′: ERISYS RDGE, an aromatic epoxy diluent, whose epoxy equivalent is 121 g/mol, available from Huntsman.
Component g-3: YED-216D, an aliphatic epoxy diluent, whose epoxy equivalent is 120 g/mol, available from Mitsubishi Chemical.

### Component (H)

Component h-1: SILQUEST A-187 silane, a coupling agent, available from Momentive.

### Examples 1 to 9 (Ex. 1 to Ex. 9) and Comparative Examples 1 to 8 (CEx. 1 to CEx. 8)

Specific amounts and types of components in the one-part curable epoxy compositions of Examples 1 to 9 according to the present invention and Comparative Examples 1 to 8 are shown in Tables 1-3. The compositions were prepared as follows: (1) mixing together all the components except the curing agent and optional curing accelerator with DAC 1200-300 VAC from FlackTek SpeedMixer at 1600 rmp for 3 minutes; and (2) adding the curing agent and optional curing accelerator in the mixture obtained in step (1), and further mixing the mixture with DAC 1200-300 VAC at 1600 rmp and 5 mbar for 3 minutes to obtain a homogeneous composition.

### Test Methods:

### Preparation of Color Plates:

Each of the compositions of Examples 1 to 9 and Comparative Examples 1 to 8 obtained above was premixed with a speed mixer and defoamed in vacuum to form a premixture to be cured, and then the premixture was injected into a polyoxymethylene mold with a dimension of 3 mm in thickness*75 mm in length*50 mm in width, and cured in an oven at 115° C. for 3 hours.

### Color Change Test Method:

The colors of the plates obtained above were measured according to ASTM E1347-06 (2020). The initial colors of the plates were measured using a CM3700A spectrophotometer from Konica Minolta, in reflectance specular component included (SCI) mode with a 10 degree observer angle. After the following Q-sun tests and pickling test simulation process, the colors of the plates were measured using exactly the same method as the above. The differences in color before and after the Q-sun tests and pickling test simulation process were calculated using the Δ E 94 calculation as designated by the International Commission on Illumination (CIE) with a 1:C ratio of 2:1 under the illuminants F02 (cool white fluorescent).

### Q-Sun Test

Q-sun tests were carried out on the plates obtained above from the compositions of Examples 1 to 9 and Comparative Examples 1 to 8 according to ASTM D4459 under the following conditions for 150 hours and 250 hours respectively:
Instruments: ATLAS Ci3000+Weather-Ometer
Irradiation intensity: 2.5 W/(M²*nm)
Chamber temperature: 35° C.
Relative humidity: 30%
Black panel temperature: 55° C.
Xenon lamp tube power: 3.57 KW

The Δ E 94 color change ≤3 after a Q-sun test under 2.5 W for 150 hours and 250 hours respectively are acceptable.

### Pickling Test Simulation Process

The pickling was carried out according to the anodization processes for electronic devices made with aluminium described in US2013/0270120A1. The process steps having the greatest impact on the color are de-smut and chemical polish. A de-smut bath was made using 30% nitric acid. A chemical polish bath was made by mixing a concentrated sulfuric acid (98%) with an 85% phosphoric acid at a weight ratio of 1:3.

In particular, the pickling test simulation process was carried out according to the following steps:

| | Process | | Temp. | Time |
|---|---|---|---|---|
| Step | step | Chemical | (° C. | (s) |
| 1 | Chemical | Phosphoric Acid(85%):Sulfuric | 85 | 180 |
| | polish | Acid(98%) = 3:1 | | |
| 2 | Rinse*2 | DI Water | RT | 60 |
| 3 | De-smut | Nitric acid(30%) | RT | 180 |
| 4 | Rinse*2 | DI water | RT | 30 |
| 5 | Dry | Air blow dry | 60 | 30 |

The Δ E 94 color change ≤3 after pickling in an anodic process of metals is acceptable.

### Lap Shear Strength for Ti to Ti, and Lap Shear Strength for AnAl to AnAl

The lap shear strengths of the compositions were measured according to ASTM D1002-10 (2019) standard with INSTRON 5900 at a maximum load of 30 KN and a tensile rate of 10 mm/min.

Modes and sizes of substrates: titanium alloy TC4, 101.6 mm×25.4 mm×2 mm; and anodized aluminum 6063, 101.6 mm×25.4 mm×2 mm.
Bonding area and thickness: 25.4 mm×12.7 mm×0.127 mm
Curing condition: 150° C.×1 hr
Number of specimens for every one composition: 5, and the results shown in the following tables are average values of 5 specimens
   Before preparing specimens, the surfaces of the substrates should be wiped with a dust-free cloth dipped in ethanol.

The lap shear strength ≥20 Mpa for Ti to Ti, and the lap shear strength ≥20 Mpa for AnAl to AnAl are acceptable.

The color changes and the lap shear strengths of the compositions were tested using the methods stated above respectively, and the results thereof are shown in Tables 1 to 3 as below.

TABLE 1

| Components | | | | | | |
|---|---|---|---|---|---|---|
| (weight in g) | | Ex. 1 | Ex. 2 | Ex. 3 | Ex. 4 | Ex. 5 |
| (A) | a-1 | 80 | 80 | 80 | 60 | 50 |
| | a-2′ | | | | | |
| (B) | b-1 | 5.6 | 5.6 | 5.6 | 5.6 | |
| | b-2 | 0.6 | 0.6 | 0.6 | 0.6 | |
| | b-3 | | | | | 24.3 |
| | b-4′ | | | | | |
| (C) | c-1 | 1 | 1 | 1 | 1 | 1 |
| (D) | d-1 | 10 | 20 | 5 | 5 | 5 |
| (E) | e-1 | 1 | 1 | 1 | 1 | 1 |
| | e-2 | 9.6 | 9.4 | 9.4 | 9.4 | 22.1 |
| (F) | f-1 | | | | | |
| (G) | g-1 | | | | 20 | |
| | g-2′ | | | | | |
| | g-3 | | | | | |
| (H) | h-1 | 0.4 | 0.4 | 0.4 | 0.4 | 0.4 |

| | | | | | |
|---|---|---|---|---|---|
| Total weight of the | 108.2 | 118 | 103 | 103 | 103.8 |
| composition (in g) | | | | | |

Test results

| | | | | | |
|---|---|---|---|---|---|
| Δ E 94 color change | 1.3 | 2.4 | 1.3 | 2.7 | 2.7 |
| after Q-Sun test under | | | | | |
| 2.5 W for 150 h | | | | | |
| Δ E 94 color change | 2.2 | 2.4 | 1.6 | 2.9 | 2.6 |
| after Q-Sun test under | | | | | |
| 2.5 W for 250 h | | | | | |
| Δ E 94 color change | 2.2 | 1.4 | 2.5 | 1.8 | 0.6 |
| after Pickling | | | | | |
| Lap shear strength, | 44.43 | 35.2 | 42.08 | 42.84 | 35.30 |
| MPa (Ti to Ti) | | | | | |
| Lap shear strength, | 29.9 | 30.3 | 29.7 | 42.85 | 32.5 |
| Mpa (AnAl to AnAl) | | | | | |

TABLE 2

| Components | | | | | | | | | |
|---|---|---|---|---|---|---|---|---|---|
| (weight in g) | | CEx. 1 | CEx. 2 | CEx. 3 | CEx. 4 | CEx. 5 | CEx. 6 | CEx. 7 | CEx. 8 |
| (A) | a-1 | | | 80 | | | | 50 | 25 |
| | a-2′ | 60 | 80 | | 50 | 25 | 25 | | |
| (B) | b-1 | 5.6 | 5.6 | 5.6 | | | | | |
| | b-2 | 0.6 | 0.6 | 0.6 | | | | | |
| | b-3 | | | | 24.3 | 27.8 | | | |
| | b-4′ | | | | | | 27.8 | 20.9 | 23.5 |
| (C) | c-1 | 1 | 1 | 1 | 1 | 1 | 1 | 1 | 1 |
| (D) | d-1 | 5 | 5 | | 5 | 5 | 5 | 5 | 5 |
| (E) | e-1 | 1 | 1 | 1 | 1 | 1 | 1 | 1 | 1 |
| | e-2 | 9.4 | 9.4 | 9.6 | 21.1 | 22.1 | 22.1 | 22.1 | 22.1 |
| (F) | f-1 | | | | | | | | |
| (G) | g-1 | | | | | | | | 25 |
| | g-2′ | 20 | | | | 25 | | | |
| | g-3 | | | | | | 25 | | |
| (H) | h-1 | 0.4 | 0.4 | 0.4 | 0.4 | 0.4 | 0.4 | 0.4 | 0.4 |

| | | | | | | | | |
|---|---|---|---|---|---|---|---|---|
| Total weight of the | 103 | 103 | 98.2 | 102.8 | 107.3 | 107.3 | 100.4 | 103 |
| composition (in g) | | | | | | | | |

Test results

| | | | | | | | | |
|---|---|---|---|---|---|---|---|---|
| Δ E 94 color change | 22.6 | 25.5 | 1 | 3.3 | 8.7 | 1.2 | 2.8 | 2.2 |
| after Q-Sun test under | | | | | | | | |
| 2.5 W for 150 h | | | | | | | | |
| Δ E 94 color change | 26.7 | 29.4 | 0.75 | 7.2 | 13.7 | 1.2 | 2.9 | 2.4 |
| after Q-Sun test under | | | | | | | | |
| 2.5 W for 250 h | | | | | | | | |
| Δ E 94 color change | 0.6 | 4.4 | 12 | 1.4 | 1.6 | 2.7 | 2 | 2 |
| after Pickling | | | | | | | | |
| Lap shear strength, | 23.08 | 22.64 | 22.28 | 39.13 | 29.24 | 39.39 | 20.74 | 28.45 |
| Mpa(Ti to Ti) | | | | | | | | |
| Lap shear strength, | 15.6 | 14.9 | 15.4 | 23.4 | 20.3 | 11.0 | 11.8 | 12.8 |
| Mpa(AnAl to AnAl) | | | | | | | | |

From the data in Tables 1 & 2, it can be seen that, the one-part curable epoxy compositions according to the present invention (Ex. 1 to Ex. 5), which comprising a combination of components (A) to (D), upon curing, exhibited both color stability and good adhesion, in particular exhibits a combination of a low color change after Q-sun test, a low color change after anodic process of metals, and a strong adhesion to metals; and especially, it exhibited a combination of Δ E 94 color changes ≤3 after Q-sun tests under 2.5 W for 150 hours and 250 hours respectively, a Δ E 94 color change ≤3 after pickling in an anodic process of metals, a lap shear strength ≥20 Mpa for Ti to Ti, and a lap shear strength ≥20 Mpa for AnAl to AnAl.

In contrast, the epoxy compositions which are not according to the present invention (CEx. 1 to CEx. 9) did not exhibit a combination of a low color change after Q-sun test, a low color change after anodic process of metals, and a strong adhesion to metals. For example, in contrast with Ex. 3, both CEx. 1 and CEx. 2 (both comprising no non-aromatic epoxy resin) exhibited Δ E 94 color changes which are much higher than 3, and lap shear strengths which are lower than 20 Mpa; and CEx. 3 (comprising no rubber with a core-shell structure) exhibited a Δ E 94 color change which is much higher than 3, and a lap shear strength which is lower than 20 Mpa. Furthermore, in contrast with Ex. 5, both CEx. 4 and CEx. 5 (both comprising no non-aromatic epoxy resin) exhibited Δ E 94 color changes which are much higher than 3; CEx. 6 (comprising a dihydrazide containing a heterocycle without a non-aromatic epoxy resin) exhibited a lap shear strength which is lower than 20 Mpa; and both CEx. 7 and CEx. 8 (both comprising a dihydrazide containing a heterocycle) exhibited lap shear strengths which are lower than 20 Mpa.

TABLE 3

| Components (weight in g) | | Ex. 6 | Ex. 7 | Ex. 8 | Ex. 9 |
|---|---|---|---|---|---|
| (A) | a-1 | 75 | 75 | 45 | 45 |
| (B) | b-1 | 5.6 | 5.6 | | |
| | b-2 | 0.6 | 0.6 | | |
| | b-3 | | | | 24.3 |
| | b-4′ | | | | |
| | b-5 | | | 24.3 | |
| (C) | c-1 | 1 | 1 | 1 | 1 |
| (D) | d-1 | 5 | 5 | 5 | 5 |
| (E) | e-1 | 1 | 1 | 1 | 1 |
| | e-2 | 9.4 | 9.4 | 22.1 | 22.1 |
| (F) | f-1 | 5 | 5 | 5 | 5 |
| (H) | h-1 | 0.4 | 0.4 | 0.4 | 0.4 |

| | | | | |
|---|---|---|---|---|
| Total weight of the composition | 103 | 103 | 103.8 | 103.8 |
| (in g) | | | | |

Test result

| | | | | |
|---|---|---|---|---|
| Δ E 94 color change after Q- | 1.32 | 1.35 | 1.33 | 1.26 |
| Sun test under 2.5 W for 150 h | | | | |
| Δ E 94 color change after Q- | 1.67 | 1.72 | 1.55 | 1.56 |
| Sun test under 2.5 W for 250 h | | | | |
| Δ E 94 color change after | 0.06 | 0.24 | 1.23 | 1.23 |
| Pickling | | | | |
| Lap shear strength, | 42.8 | 37.6 | 23.75 | 32.75 |
| MPa (Ti to Ti) | | | | |
| Lap shear strength, | 22.1 | 22.2 | 27.96 | 28.21 |
| MPa (AnAl to AnAl) | | | | |

From the data in Table 3, it can be seen that the one-part curable epoxy compositions according to the present invention (Ex. 6 to Ex. 9), which comprising a combination of components (A) to (D) together with a colorant, upon curing, also exhibited both color stability and good adhesion.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A one-part curable epoxy composition comprising:
(A) from 20 to 90 wt. % of a non-aromatic epoxy resin, based on the total weight of the composition;
(B) a non-aromatic curing agent and optionally a non-aromatic accelerator, which is a combination of a dicyandiamide and a non-aromatic urea accelerator, or a dihydrazide represented by the following general formula (I): 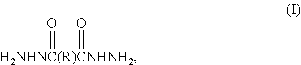
wherein R is an organic radical containing no heterocycle;
(C) a UV stabilizer; and
(D) a rubber with a core-shell structure.

2. The one-part curable epoxy composition according to claim 1, further comprising (E) a filler.

3. The one-part curable epoxy composition according to claim 2, wherein the amount of the filler (E) is from 5 to 50 wt. %, each based on the total weight of the composition.

4. The one-part curable epoxy composition according to claim 1, further comprising (F) a colorant.

5. The one-part curable epoxy composition according to claim 4, wherein the amount of the colorant (F) is from 0.1 to 10.0 wt. %, each based on the total weight of the composition.

6. The one-part curable epoxy composition according to claim 1, further comprising (G) a non-aromatic epoxy diluent.

7. The one-part curable epoxy composition according to claim 1, wherein the amount of the non-aromatic curing agent, each based on the total weight of the composition.

8. The one-part curable epoxy composition according to claim 1, wherein in the dihydrazide represented by the following general formula (I), R is a divalent hydrocarbon radical chosen from saturated or unsaturated aliphatic hydrocarbon radicals having from 2 to 20 carbon atoms, having from 10 to 20 carbon atoms.

9. The one-part curable epoxy composition according to claim 1, wherein the amount of the non-aromatic epoxy resin (A) is from 30 to 90 wt. %, each based on the total weight of the composition.

10. The one-part curable epoxy composition according to claim 1, comprising:
(A) from 55 to 85 wt. %, each based on the total weight of the composition;
(B) from 3 to 10 wt. %, each based on the total weight of the composition;
(C) a UV stabilizer;
(D) a rubber with a core-shell structure; and
(E) optionally, from 5 to 20 wt. %, each based on the total weight of the composition.

11. The one-part curable epoxy composition according to claim 1, comprising:
(A) from 20 to 55 wt. %, of a non-aromatic epoxy resin, each based on the total weight of the composition;
(B) from 15 to 35 wt. %, of the dihydrazide represented by the general formula (I) as defined in claim 1, each based on the total weight of the composition;
(C) a UV stabilizer;
(D) a rubber with a core-shell structure; and
(E) optionally, from 17 to 30 wt. %, each based on the total weight of the composition.

12. The one-part curable epoxy composition according to claim 1, further comprising (H) a coupling agent.

13. A cured product of the one-part curable epoxy composition according to claim 1.

14. An article comprising the cured product according to claim 13.
